(19) United States
(12) Patent Application Publication
(10) Pub. No.: US 2016/0330284 A1
(43) Pub. Date: Nov. 10, 2016

(54) SYSTEMS AND METHODS FOR SERVER BASED PROCESSING OF ON BOARD DIAGNOSTICS (OBD) DATA

(71) Applicant: Novatel Wireless, Inc., San Diego, CA (US)

(72) Inventors: Michael Holck, Sachse, TX (US); Jim Korns, Richardson, TX (US); Tiger Guan, Guangzhou (CN)

(21) Appl. No.: 14/706,846

(22) Filed: May 7, 2015

(51) Int. Cl. H04L 29/08; G07C 5/00; H04L 12/58; G07C 5/08

(52) U.S. Cl. CPC H04L 67/12; G07C 5/085; G07C 5/008; H04L 51/18

(57) ABSTRACT

An example method includes receiving data indicative of an asset identifier associated with a mechanical asset coupled to a communication device. The communication device is configured to retrieve data from a monitoring device of the mechanical asset. The method further includes receiving data indicative of a device type of the communication device, determining characteristics of an asset type based on the asset identifier data, and storing data indicative of the asset type, the determined characteristics, and the communication device type. Based on the determined characteristics and the communication device type, the method further includes determining a configuration for the communication device to retrieve the data from the monitoring device. The determined configuration is the communicated to the communication device.

### TECHNICAL FIELD

The present application relates generally to systems and methods for configuring on board diagnostic (OBD) devices, and more particularly, to systems and methods for remotely configuring OBD devices to operate with specific vehicle types.

### BACKGROUND

On board diagnostics (OBD) can refer to a vehicle's self-diagnostic and reporting capability. OBD systems can give an owner of the vehicle, or a repair technician, access to certain data/information relevant to operation of the vehicle, e.g., state of health information. While early instances of OBD involved the illumination of, e.g., a malfunction indicator light, more recent instances of OBD can use digital communications to provide data, such as real-time data, in addition to a standardized series of diagnostic trouble codes, for identifying and remedying malfunctions within a vehicle.

An OBD device can refer to an electronic apparatus that connects with an OBD port of, e.g., a vehicle, and reads data from the vehicle.

### SUMMARY

Various embodiments are set out in the claims.

According to a first embodiment, a method includes receiving data indicative of an asset identifier associated with a mechanical asset coupled to a communication device, the communication device configured to retrieve data from a monitoring device of the mechanical asset, receiving data indicative of a device type of the communication device, determining characteristics of an asset type based on the asset identifier data, storing data indicative of the asset type, the determined characteristics, and the communication device type; and based on the determined characteristics and the communication device type, determining a configuration for the communication device to retrieve the data from the monitoring device.

According to a second embodiment, a system includes at least one server device, the at least one server device configured to receive data indicative of an asset identifier associated with a mechanical asset coupled to a communication device, the communication device configured to retrieve data from a monitoring device of the mechanical asset. The at least one server device is further configured to receive data indicative of a device type of the communication device, determine characteristics of an asset type based on the asset identifier data, store data indicative of the asset type, the determined characteristics, and the communication device type, and based on the determined characteristics and the communication device type, determine a configuration for the communication device to retrieve the data from the monitoring device.

According to a third embodiment, a communication device includes a processor; and a memory storing program code. The program code is configured to cause the processor and the communication device to retrieve an asset identifier from a monitoring device monitoring a mechanical asset, the communication device being communicatively coupled the monitoring device, send data indicative of the asset identifier to a remote server device, send data indicative of a device type of the communication device to the remote server device, and, subsequent to sending the data indicative of the asset identifier and the device type, receiving data indicative of a configuration to retrieve data from the monitoring device, the configuration being based on characteristics of an asset type associated with the mechanical asset identified by the asset identifier and the device type.

### BRIEF DESCRIPTION OF THE DRAWINGS

For a more complete understanding of example embodiments, reference is now made to the following descriptions taken in connection with the accompanying drawings in which:

FIG. 1 illustrates an example system for configuring an OBD device for processing of on board diagnostics (OBD) data from a particular vehicle;

FIG. 2 illustrates an example of class variables that may be used to categorize vehicle types;

FIG. 3 illustrates an example database schema for storing user data, vehicle type data and OBD device type data in association with each other;

FIG. 4 illustrates a message flow sequence of an example process for configuring an OBD device for operation through automatic detection of vehicle information with a certain vehicle type using elements of the system of FIG. 1;

FIG. 5 illustrates a message flow sequence of another example process for configuring an OBD device for operation through directed configuration of vehicle information with a certain vehicle type using elements of the system of FIG. 1;

FIG. 6 is a flow chart of an example process for discovery of an OBD device type and a vehicle type pair and for determining a configuration for the OBD device based on the pairing;

FIG. 7 is a flow chart of an example process for configuring an OBD device with a configuration based on a pairing of the OBD device with a specific vehicle type; and

FIG. 8 is a flow chart of an example process for receiving engine computer unit data from an OBD device.

### DETAILED DESCRIPTION OF THE DRAWINGS

Various embodiments in accordance with the disclosure are directed to systems and methods for configuring different types of wireless communication devices (e.g., OBD devices) for collecting data from different types of mechanical assets such as, for example, different vehicle types. Such configuring may allow for more complete collection and analysis of data and for updating of configurations due to changes in the communication device and/or changes in monitoring devices associated with the mechanical asset, e.g., an engine control unit (ECU).

The systems and methods described herein, may enhance the functionality of devices that gather, compile and perform operations on data, e.g., OBD devices, thus enhancing their utility and convenience. Systems and methods described herein will be described in reference to OBD devices that are coupled to vehicles, but the systems and methods may apply to other types of communication devices coupled to monitoring devices associated with other types of assets (e.g., machinery, boats, airplanes, etc.). An OBD device can refer to an electronic apparatus that can be connected to an OBD port of a vehicle to read relevant data/information from one or more vehicle computer systems. That is, the OBD device can connect to an ECU, for example. The ECU may use a microprocessor to control various aspects of a vehicle's engine to ensure optimum operation. The ECU may read information from various sensors, looking at, e.g., ignition timing, idle speed, controlling air/fuel ratios, etc. to glean relevant information and make adjustments to the vehicle's engine. Such information and data may be gathered and analyzed with the help of an OBD device to diagnose faults or enhance engine performance. Still other OBD systems can connect to vehicle emission control systems and detect malfunctions that could cause the vehicle's emissions to run afoul of Environmental Protection Agency (EPA) thresholds.

An OBD device that includes an integrated radio modem, may utilize a communications network, such as a wireless wide area network (WWAN), cellular network, and/or satellite network, for example, to communicate relevant data/information to some remote location, e.g., a diagnostic computer, without the need for a wired connection. With increased support for, and availability to vehicle OBD data, there is increasing demand for collection and analysis of vehicle information. This increased demand, combined by the existence of several different types of OBD devices deployed in different types of vehicles for different reasons, has complicated the collection and analysis of vehicle information.

By providing a back end server application that can efficiently direct the collection of this data, and provide it in a meaningful format to higher end applications, a number of needs can be addressed. Examples of these needs may include, for example:
Tracking of scheduled maintenance, based upon both time and mileage based periodic maintenance (e.g. oil and belts), and maintenance based upon vehicle events (e.g. tire pressure)
Driver monitoring, both in terms of hours of activity (e.g. hours worked) and behavior (e.g. excessive revolutions per minute or RPM)
Enhanced vehicle scheduling (e.g. scheduling a vehicle requiring maintenance to deliver near a proper facility)
Insurance monitoring, in terms of miles traveled, vehicle speed, collision detection

Limited OBD data is currently being accessed by remote monitoring systems. This may be due to a number of issues such as, for example:
Lack of standardized OBD parameter identifier (PID) values make it impossible to have a single configuration supporting all vehicles
Lack of support for the PIDs that are standardized make presence of data unpredictable

Objects of the systems and methods described herein include, but are not limited to:
Automatically recognizing the vehicle being monitored by accessing commercially available databases and/or locally maintained databases
Automatically determining what OBD PIDs are available for a particular vehicle by accessing a vehicle database, correlating a make/model/year with available PIDs and associated access information
Reconfiguring the OBD device to extract the maximum amount of data that is available from the particular vehicle by providing the OBD device with the necessary parameters for accessing the available PIDs, such parameters including, but not limited to, the bus identifiers, the PID identifiers, and any timing related parameters
Allowing access to the resultant data by an external application by adding appropriate entries to applications in the OBD device, and notifying the applications of the presence of additional data available from the particular vehicle

In addition, when new information about specific vehicles becomes available, the systems and methods described herein may be used for:
Automatically recognizing new information available for all vehicles being updated
Automatically reconfiguring all deployed OBD devices in all vehicles that are applicable to the update
Allowing access to the enhanced data by an external application

Further, if automatic reconfiguration of the vehicle is hindered, e.g., due to a failure to identify the vehicle type and or the OBD device type, manual intervention may be utilized such that a user can specify the vehicle type, the OBD device type, and this data may be used to identify other vehicles and/or OBD devices with the same or similar characteristics.

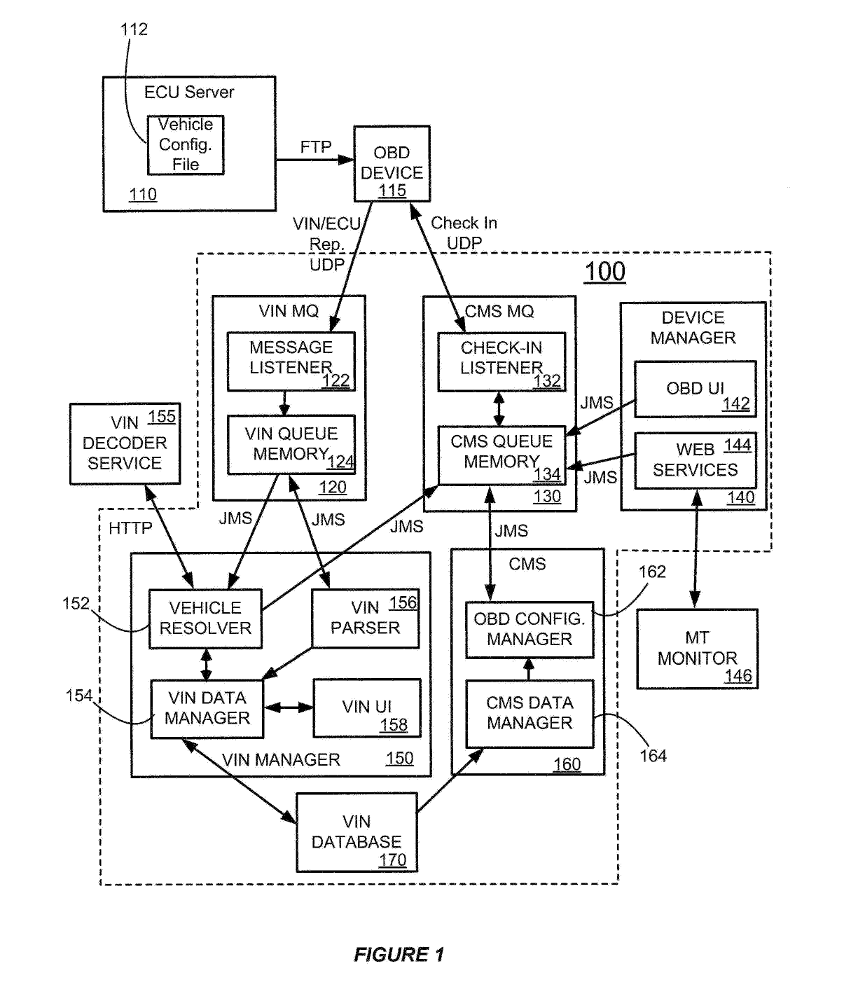

FIG. 1 illustrates an example OBD configuration management system 100 for configuring an OBD device for processing of on board diagnostics (OBD) data from a particular vehicle. The example OBD configuration management system 100, referred to from herein as the “system” 100, may include several components including, in this example, a plurality of OBD devices 115 (only a single OBD device is illustrated), a vehicle identification number (VIN) manager 150, a communication management system (CMS) 160 and a device manager 140.

Each of the OBD devices 115 is coupled to a vehicle that includes a data source such as, in this example, an engine control unit (ECU) server 110. The ECU server 110 is equipped with a particular configuration for uploading data (e.g., via a file transfer protocol, or FTP bus) to the OBD device 115, as determined by a vehicle configuration file 112. The OBD device 115 may be configured by the system 100 to obtain the ECU data contained in the vehicle configuration file 112 via the FTP bus. The OBD device 115 may be configured to read data from the vehicle configuration file 112, determine Global Positioning System (GPS) location, and communicate the ECU data and GPS data over a cellular network, or other wireless network, to the system 100.

The VIN manager 150, the CMS 160 and the device manager 140 may be part of an integrated server system or, alternatively, may be implemented as two or more separate server systems communicatively coupled via a network (e.g., the Internet, wireless networks, satellite networks, etc.). The VIN manager 150 and the CMS 160 communicate with the OBD device 115 in order to obtain vehicle identification data (e.g., a VIN) and OBD device type data and determine, based on this data, how best to configure the OBD device 115 to interact with the particular ECU server 110 of the particular vehicle type that the OBD device 115 is paired with.

The device manager 140 allows for a fleet of devices to be maintained by the system 100. This maintaining may include the scheduled deployment of configurations for OBD devices 115, automatic reconfiguration and revision control of the OBD devices 115, and reconfiguration of devices based upon the observed environment. The CMS 160 allows for an external application to easily access information being collected from the OBD devices 115, and schedule delivery of any configuration application data that needs to be delivered from an external OBD or ECU related application, for example, to an OBD device 115.

The OBD device 115 may access the ECU server 110 using appropriate busses to monitor the ECU. The appropriate busses may be communicated to the OBD device 115 in a configuration determined by the CMS 160 and, in this example system 100, communicated by the CMS 160 to the OBD device 115. The OBD device 115, depending on the OBD device type, has access to at least one, and, in current deployments, as many as four different vehicle busses. The quantity of busses is determined by the vehicle manufacturer, and may increase as vehicles continue to increase in complexity.

The VIN is located in a standardized PID, and can be accessed in most vehicles by any OBD device 115 without detailed knowledge of the vehicle. When an OBD device 115 is first installed in a vehicle, or activated the first time, or reactivated, the OBD device 115 may read the VIN PID from the ECU server 110 via the standardized bus. The OBD device 115 then communicates the VIN and an identification number or OBD model number, in a VIN report message, to the VIN manager 150 via a VIN manager queue (MQ) module 120. The VIN MQ module 120 may be integrated with a server of the VIN manager 150, or may be a standalone server, depending on the embodiment.

The VIN MQ module 120 includes a message listener 122 that retrieves the VIN message off a communication network (e.g., the Internet, cellular or satellite network, etc.) and a message queue, implemented in a VIN message queue memory 124 (e.g., RAM, . . . ) that stores the VIN message until the VIN manager 150 is ready to retrieve the VIN message. In one embodiment, the message listener 122 listens to a User Datagram Protocol (UDP) socket for the VIN reports (and ECU reports as described below) from the OBD devices 115, and stores them in the VIN message queue memory 124 for further processing by the VIN manager 150. The message listener 122 binds to a configurable UDP port and listen for reports. This can be done using any of a variety of software packages. The message listener 122 may not process the reports that it retrieves, but may simply build a Java Message Service (JMS) message out of it and push it onto the VIN message queue memory 124.

In one embodiment, the VIN message queue memory 124 is a JMS queue. This approach may provide for handling higher volumes of reports and may avoid losing reports if the VIN manager 150 gets busy. A properties file is provided to the message listener 122 that instructs the listener how to configure itself to listen to the UDP port as well as providing the location of a JMS broker of the VIN message queue memory 124 to push the reports onto. The VIN message queue memory 124 may use a JMS broker for providing the message queuing.

In addition to sending the VIN report message, subsequent to being configured for the ECU server 110 installed in the specific vehicle, the OBD device 115 also sends ECU report messages to the VIN manager 150 via the VIN MQ module 120. The ECU report messages include data that the OBD device 115 retrieves from the ECU server 110. The ECU report messages may include the ECU version (if readable) and a status for each OBD collection command sent to let the VIN manager 150 know which commands work on that specific vehicle. This data can be used later to refine the configuration scripts for specific vehicles. As will be described below, the data in the ECU messages may be parsed by the VIN manager 150 and then communicated to the device manager 140 for later retrieval by a user associated with the OBD device 115, a repair person, an insurance agent, etc. Details of the VIN report message and the ECU messages are described below.

The VIN manager 150 includes several modules including, in this example, a vehicle resolver 152, a VIN data manager 154, a VIN parser 156 and a VIN user interface (UI) 158. The VIN parser 156 retrieves VIN report messages and ECU report messages from the VIN MQ module 120. In one embodiment, the VIN parser 156 pulls the messages off the JMS queue of the VIN queue memory 124, then parses the messages into components. Some older messages may not include the additional fields, described below, that have been added to the messages in order to implement the configuration management methods described herein. For these older messages, the VIN parser 156 may parse and identify these older cases, where the additional fields are missing, and handle them using previous methods, not described herein.

A VIN report message may be a standard format including a VIN and OBD device type identifier. The VIN parser 156 parses the VIN and the OBD device type data from the VIN report message and provides the parsed data to the VIN data manager 154. Once the VIN parser 156 has identified a VIN report message, and has parsed out the VIN and the OBD device type identifier, it may create a message, e.g., a JMS message, that will be passed on to the vehicle resolver 152 to get the vehicle specific information. The VIN parser 156 also reports the information parsed from the VIN report to the VIN data manager 154 such that the VIN data manager 154 may queue the report message and store this new data in a VIN database 170 such that the new VIN/OBD device type pair persists in the VIN manager 150. Queuing these messages allows for a slower response from the vehicle resolver module 152 as well as for flexibility in the future to add additional logic to the resolution process.

Upon receiving a new VIN that was reported in a VIN report message, the vehicle resolver 152 resolves the VIN into a year, make, model, trim, and engine type of the vehicle, for example. The vehicle resolver 152 may resolve the VIN by querying one or more VIN decoder services 155. A number of VIN decoder services 155 are available. In the US, Edmunds offers a relatively complete database, with a well defined application programming interface (API). Similar examples exist in a number of other countries. In addition to the external VIN decoder services 155, the vehicle resolver 152 may include one or more local versions of VIN decoders for resolving, for example, specific VINs that require manual data entry or decoding.

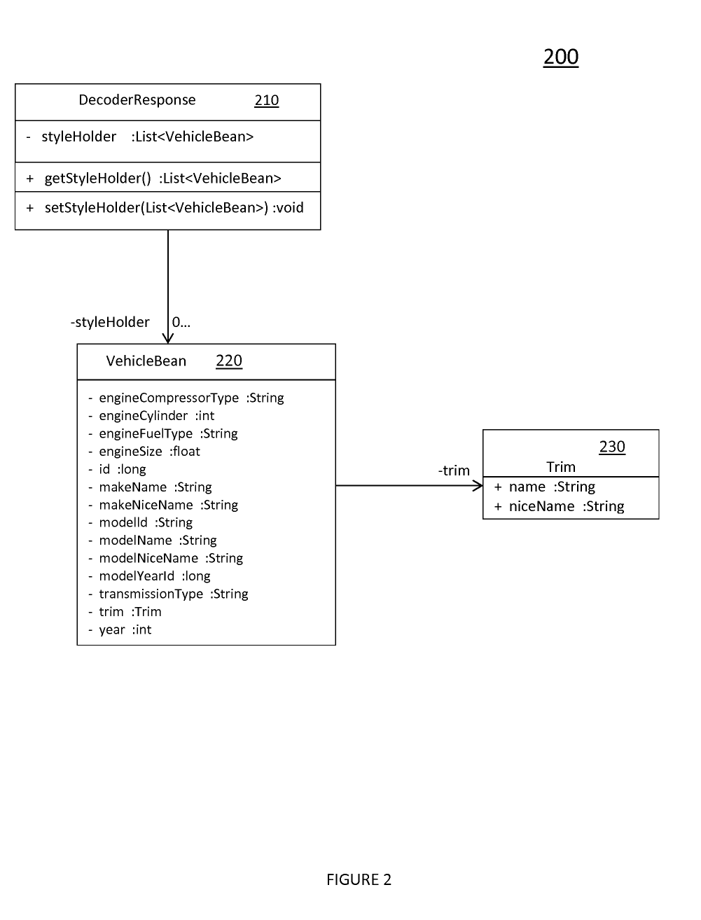

Referring now to FIG. 2, an example of an entity object component (or entity bean in the case of JAVA) 200 that may be used to categorize vehicle types by the VIN decoder service 155 is shown. As used herein, an entity object component (or entity bean) is any set of objects that represents persistent data maintained in a database. The different variables/arrays of the object component 200 may be derived from one or more third party web services for resolving VINs to vehicles. These third party web services may be one or more commercial offerings (e.g. Edmond's), proprietary implementations derived from independent research, or combination of the above. The entity object component 200 includes a response object 210 received from the VIN decoder service 155.

The object component 200, in this embodiment, includes a VehicleBean array 220 containing the vehicle characteristics variables. The vehicle characteristics variables, in this example, include engineCompressorType, engineCylinder (number of cylinders), engineFuelType (e.g., diesel, regular unleaded, premium, etc.), engineSize (e.g., 2.5 liter, 4.0 liter, etc.), id (VIN), makeId (manufacturer identifier number), makeName (e.g., Chevrolet, Ford, Toyota, etc.), makeNiceName (all lower case version of makeName), modelId (model identifier number), modelName (e.g., Altima Sedan, Focus Hatchback, Impala Convertible etc.), modelNiceName (e.g., sedan, hatchback, convertible, etc.), modelYearId (identifier of multiple models of the same name in the same year), transmissionType (e.g., automatic, manual, etc.), trim (trim package name) and year (year of manufacture, e.g., 1998, 2002, 2014, etc.). Other variables may be included in the VehicleBean array 220, depending on the embodiment.

The trim variable is characterized by a trim array 230 that includes two variables including Trim.name (e.g., 2.5 SL 4 dr Sedan (w.5L 4 cyl CVT), etc.), and Trim.niceName (shortened, all lower case version of Trim.name variable). A trim package (sometimes called an appearance package) is an automotive package composed by a set of cosmetic (mostly non-functional) embellishments to a vehicle. In some cases, the trim package may include a specific model or ending name. The object component 200 of FIG. 2 is exemplary only and other class definitions may be used.

The vehicle resolver 152 may make use of known JAVA libraries to convert the response (e.g., a JSON response) received from the VIN decoder service 155 into the objects of the class objects 200. For example, the Gson library is a Java library provided by Google that can be used to convert Java Objects into their JSON representation and vice-versa. Once the vehicle resolver 152 has resolved the VIN to a year, make, model, trim and engine type, it will update the record in a local database with this information.

After resolving the VIN into year, make, model, trim, and engine type, the vehicle resolver 152 provides this resolved data to the VIN data manager 154, which stores this data in the VIN database 170. The VIN Data Manager 154 is responsible for all data interactions with the VIN database 170. A VehicleBean array 220 will be generated for each vehicle model and the VIN data manager 154 converts any data in the VehicleBean array 220 into the appropriate format for insertion into the VIN database 170. The VIN Data Manager 154 also handles all reading from the VIN database 170 as provided by the VIN UI 158. The VIN Data Manager 154 may be packaged in a JAR (Java Archive) file that can be reused in any server context using the Java platform.

The VIN UI 158 provides a user interface for the VIN manager 150. The VIN UI 158 may be a front end web application for managing the OBD/Vehicle paired data. In one embodiment, the VIN UI 158 is not a customer facing application but rather an internal application used by people running the VIN manager 150 for querying, editing, deleting, and manually adding data into the VIN database 170. For example, if the VIN decoder service 155 (e.g., Edmunds or a United Kingdom vehicle registration mark (VRM) resolver service) is not able to resolve every VIN to year, make, model, and trim, etc., some of these variables will need to be manually edited. In addition, there may sometimes be external testing done with OBD devices 115 in specific vehicles that have not reported through the VIN Listener 122 and may need to be manually added. This VIN UI 158 may also be the main interface for querying what vehicle types are known to be supported and which PIDs are supported by each known vehicle make and model.

The VIN UI 158 may utilize a Spring Web model-view-controller (MVC) as a front end that provides a service interface between the front end of the VIN manager 150 and the VIN data manager 154 for any business logic or data manipulation. Other MVCs may also be utilized. The MVC framework may be designed around a DispatcherServlet that dispatches requests to handlers, with configurable handler mappings, view resolution, locale, time zone and theme resolution as well as support for uploading files. The default handler may be based on the @Controller and @RequestMapping annotations, offering a wide range of flexible handling methods. With the introduction of Spring 3.0, the @Controller mechanism also allows a user to create RESTful Web sites and applications, through the @PathVariable annotation and other features.

The VIN Database 170 maintains a local identification of all vehicles and all OBD devices 115 monitoring the vehicles that are being managed by the VIN manager 150. The VIN Manager 150 communicates an indication of the newly stored VIN/vehicle type data to the CMS 160 to notify it that a new OBD device 115 has been associated with a new vehicle type such that the CMS 160 may schedule a deployment of an appropriate configuration file for that OBD/vehicle pairing.

The VIN database 170 may be used for storing and querying all VIN data reported from the OBD devices 115. In one example, the VIN database 170 may be a relational database management system (RDBMS) that is based on a relational model. Many popular databases currently in use are based on the relational database model. RDBMSs have become a predominant choice for the storage of information in new databases used for financial records, manufacturing and logistical information, personnel data, etc. Relational databases have often replaced legacy hierarchical databases and network databases because they are easier to understand and use. As an alternative to the VIN database 170 being an RDBMS, the VIN database 170 may be an object database.

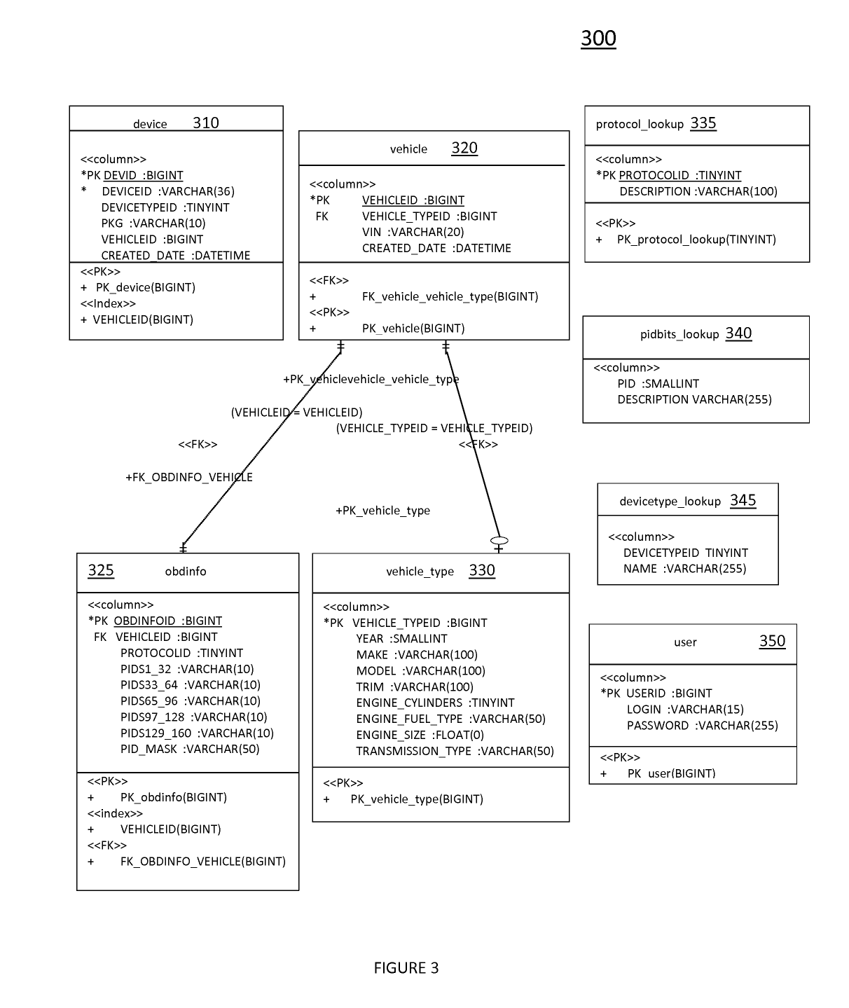

Referring now to FIG. 3, an example database schema, or entity relationship diagram (ERD) 300 for storing user data, vehicle type data and OBD device type data in association with each other in the VIN database 170 is shown. The ERD 300 of FIG. 3 is an example of data objects that may be used to store data in the VIN database 170. The example ERD 300 includes the following Objects:
Device object 310—object identifying a specific OBD device 115 and the associated vehicle (see VEHICLEID variables below) of a device/vehicle pair
   DEVID—identifier of a specific OBD device
      DEVICEID—OBD device 115 identifier number
      DEVICETYPEID—identifier of an OBD device type
      PKG—version of firmware on OBD device 115
      VEHICLEID—identifier of specific vehicle paired with OBD device 115
      CREATED_DATE—date and time the device/vehicle pairing was made
Vehicle object 320—object identifying a specific vehicle of a device/vehicle pair
   VEHICLEID—identifier of specific vehicle
      VEHICLE_TYPEID—identifier of associated vehicle type
      VIN—Vehicle Identification number of specific vehicle
      CREATED_DATE—date and time the device/vehicle pairing was made
Obdinfo object 325—object identifying characteristics of OBD device 115 paired with a specific vehicle
   OBDINFOID
      VEHICLEID—identifier of specific vehicle
      PROTOCOLID—identifier of specific OBD protocol supported by the specific vehicle
      PIDS1_32—first bitmask of PID bits supported
      PIDS33_64—second bitmask of PID bits supported
      PIDS65_96—third bitmask of PID bits supported
      PIDS97_128—fourth bitmask of PID bits supported
      PIDS129_160—fifth bitmask of PID bits supported
      PID_MASK—combined bitmask of PID bits supported
Vehicle_type object 330—object identifying vehicle type characteristics associated with a specific vehicle of a device/vehicle pair
   VEHICLE_TYPEID
      YEAR—year of manufacture of specific vehicle
      MAKE—manufacturer name of specific vehicle
      MODEL—model name of specific vehicle
      TRIM—trim package name of specific vehicle
      ENGINE_CYLINDER—number of engine cylinders of specific vehicle
      ENGINE_FUEL_TYPE—fuel type (diesel, regular, premium, etc.) of specific vehicle
      ENGINE_SIZE—engine displacement of specific vehicle
      TRANSMISSION_TYPE—type of transmission (manual or automatic) of specific vehicle
Protocol_lookup object 335—object providing lookup table to identify OBD protocol type associated with each PROTOCOLID (see obdinfo object 325)
   PROTOCOLID—identifier of specific OBD protocol
      DESCRIPTION—name of OBD protocol
Pidbits_lookup object 340—object providing lookup table to identify descriptions of ECU measurements indicated by specific PID bits
   PID—identifier of a PID
      DESCRIPTION—name of measurement associated with a PID
Devicetype_lookup object 345—object providing lookup table to identify an OBD device type associated with a specific DEVICETYPEID (see device object 310)
   DEVICETYPEID—identifier of an OBD device type
      NAME—name of OBD device type indicated by specific DEVICETYPEID
User object 350—object identifying user that may be associated with multiple OBD device/vehicle pairings
   USERID—identifier of a specific user
      LOGIN—username of specific user
      PASSWORD—password associated with LOGIN username

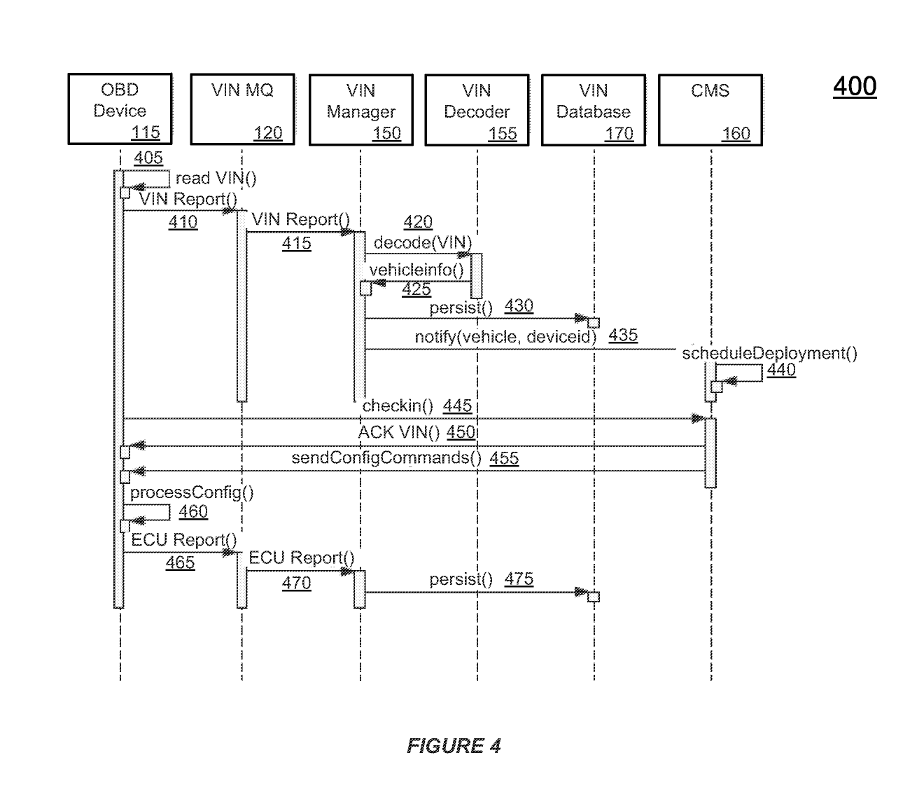

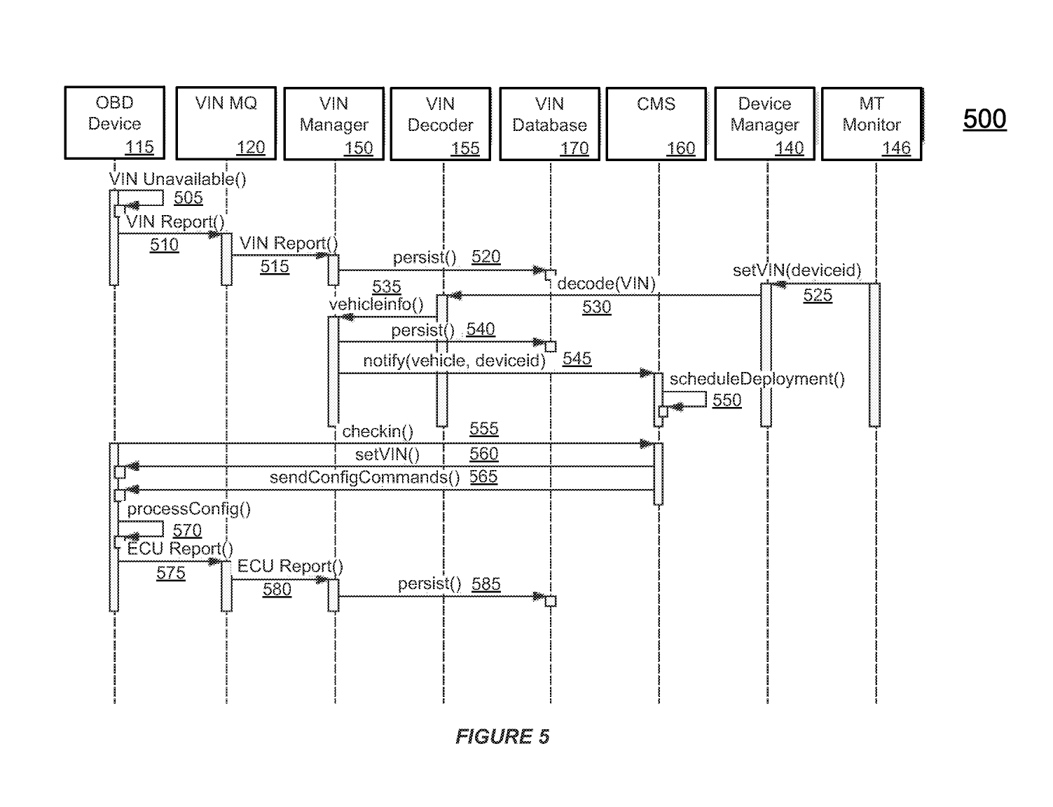

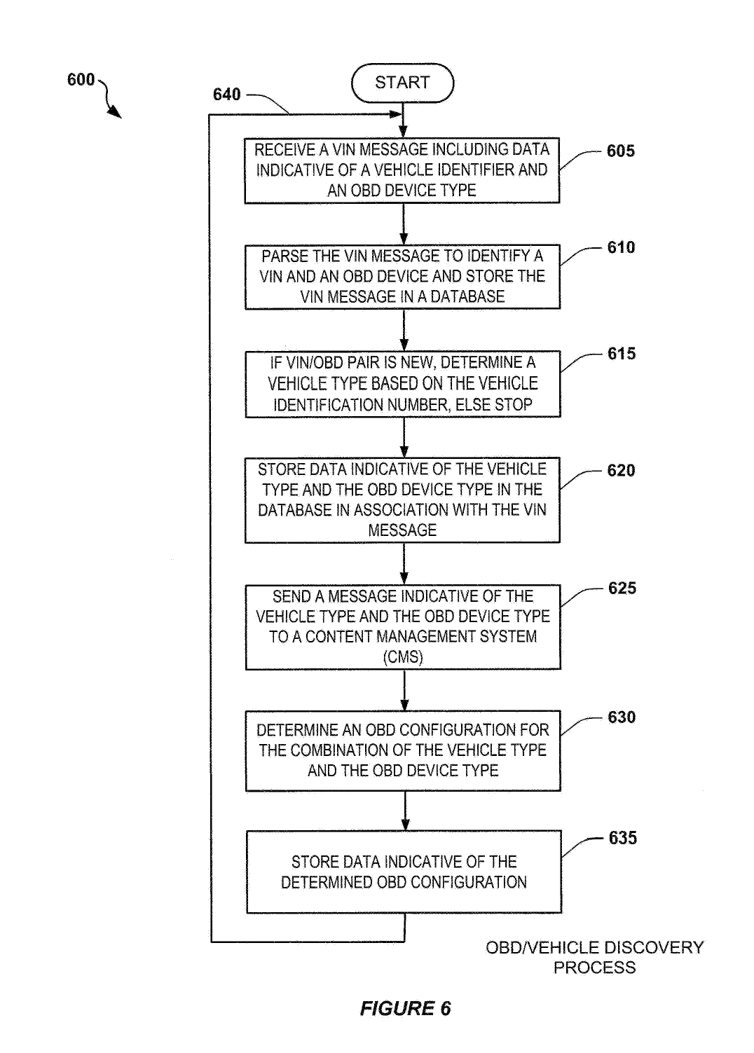

Details of how the ERD 300 is populated with data will be addressed below in reference to the message flow diagrams of FIGS. 4 and 5 and the processes shown in FIGS. 6, 7 and 8.

Referring once again to FIG. 1, the VIN Manager 150 communicates an indication of a newly stored VIN/vehicle type data to the CMS 160 to notify it that a new OBD device 115 has been associated with a new vehicle type such that the CMS 160 may schedule a deployment of an appropriate configuration file for that OBD/vehicle pairing. The CMS 160, when notified of a new vehicle, or enhancements to data available to existing vehicles, schedules a modification of the device deployment to allow collection of data of interest.

The CMS 160 may provide general access to data collected from mobile OBD devices 115, and allow additional messages to be sent to the OBD devices 115 based on enhancements to OBD application upgrades, for example. The OBD application may be enhanced to take advantage of the availability of additional configuration capabilities, either by recognition of a new device/VIN correlation, or an update in available information from a known VIN. The CMS 160 may queue deployment for transmission to an OBD device 115, and the next time this device “checks in” with CMS 160 (typically done on a time scheduled basis), this new deployment is automatically sent to the OBD device 115. After deployment, the OBD device 115 sends the data per the new configuration to the VIN manager 150 via the VIN MQ 120, the VIN manager 150 stores the new data in the VIN database 170, and the CMS 160 may present it to the OBD application of the Device manager 140.

The CMS 160 includes an OBD configuration manager module 162 and a CMS data manager module 164. The OBD Configuration Manager module 162 processes scheduled configuration notifications to OBD devices 115 for OBD device 115/vehicle pairings that are identified by the Vehicle Resolver 152 and selects the appropriate configuration file for the determined device/vehicle pairing and schedules a deployment to the OBD device 115 with the necessary AT command pointing to the file. The AT is an ATTENTION command used in wireless communications and is used as a prefix to other parameters in a string.

The CMS data manager module 164 may function in coordination with the VIN data manager 154 in that the CMS data manager 164 coordinates retrieving data from the VIN database 170 that the VIN data manager 154 has stored in the VIN database 170.

The OBD configuration manager module 162 receives messages from OBD devices 115 (e.g., check-in messages as described below) and sends configuration messages to OBD devices 115 via a CMS message queue (MQ) module 130. In addition, the OBD configuration manager module 162 communicates configuration files to be communicated to OBD devices 115 to the CMS MQ module 130 to be transmitted to OBD devices 115 upon check-in by the OBD devices 115.

The CMS MQ module 130 includes a check-in listener module 132 and a CMS message queue memory 134. The CMS MQ module 130 may be similar to the VIN MQ module 120 described above. For example, the check-in listener 132 may be similar to the message listener 122 and the CMS message queue memory 134 may be similar to the VIN message queue memory 124. The messages sent to and received by the CMS MQ module 130 may be JMS messages, UDP messages or other forms of messages.

The CMS 160 also communicates with the device manager 140 via the CMS MQ module 130. The device manager 140 may provide a customer facing OBD UI 142 as well as web services 144 to be used by the OBD device customer for setting or getting OBD related data. The OBD UI 142 may show data to the OBD customer based on the OBD device/vehicle pairing association for each OBD device 115 based on the configuration file that has been sent to that OBD device 115. The device manager 140 may also provide the ability for the customer to clear the association of a particular VIN to a particular OBD device 115 or to manually enter the associated VIN if the VIN was not properly reported to the VIN manager 150 by the OBD device 115. The Web Services 144 may provide various methods to allow a user to specify the VIN for a device through an MT Monitor application 146, as will be described below.

FIG. 4 illustrates a message flow sequence 400 of an example process for configuring an OBD device 115 for operation with a certain vehicle type using elements of the system of FIG. 1. The message flow sequence 400 includes three main portions, an initial VIN reporting portion including steps 405, 410, 415, 420, 425, 430, 435 and 440, a check-in portion including steps 445, 450, 455 and 460, and an ECU reporting portion including steps 465, 470 and 475. The message flow sequence 400 involves the OBD device 115, the VIN MQ 120, the VIN manager 150, the VIN decoder 155, the VIN database 170 and the CMS 160. In the message flow sequence of FIG. 4, the VIN is successfully reported to the VIN manager 150 from the OBD device 115, and successfully decoded by the VIN decoder 155.

The message flow sequence 400 starts at step 405 with the OBD device 115 reading the VIN from the ECU server 110 of the vehicle. At step 410, the OBD device 115 sends the VIN report message to the VIN MQ 120 which stores the VIN report message in the VIN queue memory 124. At step 415, the VIN manager 150 retrieves the VIN report message from the VIN MQ 120. Subsequent to the VIN manager 150 retrieving the VIN report message, the VIN parser 156 parses the VIN from the VIN report message and provides the VIN to the vehicle resolver 152 which sends the VIN to the VIN decoder service 155 at step 420.

At step 425, the VIN decoder service 155 successfully retrieves vehicle characteristics based on the VIN and sends the vehicle characteristics to the VIN manager 150 which stores the vehicle characteristics as a persistent object in the VIN database 170 at step 430. At step 435, the VIN manager 150 notifies the CMS 160 of the newly retrieved OBD device 115/vehicle paring. At step 440, the CMS 160 determines a configuration for the OBD device 115/vehicle pairing and schedules the configuration to be deployed when the OBD device 115 checks in.

The check-in portion of the message flow sequence 400 starts at step 445 where the OBD device 115 sends a check-in message to the CMS 160 via the CMS MQ 130 (not shown in FIG. 4). At step 450, the CMS 160 sends an acknowledgement message (ACK VIN) to the OBD device 115 verifying that the CMS 160 received the check-in message with the VIN. At step 455, the CMS 160 sends messages to the OBD device 115 that provide the configuration for the OBD device 115 to later report ECU messages. At step 460, the OBD device 115 processes the received configuration messages, thereby setting up the configuration for reporting future ECU messages.

The raw reporting data later retrieved from the ECU by the OBD device 115, via various busses, is of varying lengths of bytes. The configuration messages sent by the CMS 160 at step 455 include algorithms necessary to transform the raw data, by performing one of many methods of conversion, to a final usable value. These conversion methods may include scaling, shifting, masking, or combinations of these, in order to get the data into values usable by the other components of the system 100. The configuration may also include various algorithms to perform any necessary unit conversion (i.e. km to miles) in order to achieve a uniform data representation for reporting. This is desirable since data retrieved from the vehicle is typically devoid of any unit designations.

The ECU reporting portion of the method flow diagram 400 starts at step 465 with the OBD device 115 creating an ECU report based on ECU data received from the ECU server 110 and sending the ECU report to the VIN MQ 120. The ECU report includes an identifier such as an identifier of the OBD device 115 and/or an identifier of the vehicle. Upon receiving the ECU report and storing the ECU report in the VIN queue memory 124, the VIN manager 150 retrieves the ECU report at step 470 (e.g., with the VIN parser 156), and parses the ECU report with the VIN parser 156. At step 475, the VIN manager 150 stores the ECU data as persistent data in the VIN database 170. The data is stored in association with the identifier of the OBD device 115 and/or the identifier of the vehicle (e.g., in an RDBMS such as illustrated in FIG. 3).

After the ECU data is stored in the VIN database 170, the CMS 160 may retrieve the data when needed. For example, the CMS 160 may retrieve data from the VIN database based on a user request received via the device manager 140. Further details of the VIN message reporting portion, the check-in portion and the ECU message reporting portion will be described in reference to FIGS. 6, 7 and 8, respectively, below.

FIG. 5 illustrates a message flow sequence 500 of another example process for configuring an OBD device 115 for operation with a certain vehicle type using elements of the system 100 of FIG. 1. In contrast to the message flow sequence 400 of FIG. 4, the message flow sequence 500 is used when a VIN is not properly reported by the OBD device 115 and a manual input of a VIN, via the data manager 140, for example, is used.

At step 505, the OBD device 115 is unable to read the VIN from the ECU server 110. At stage 510, the OBD device 115 sends a VIN report message to the VIN MQ 120. At step 515, the VIN manager 150 retrieves the VIN report message from the VIN MQ 120. In this example, the VIN report message includes a VIN with all zeroes so the VIN manager 150 knows that the VIN was unable to be retrieved. At step 520, the message flow 500 departs from the message flow 400 since the VIN is not available in the VIN report message received at steps 410 and 415. The VIN may not be included in the VIN report message for several reasons. For example, the OBD device 115 may not be compatible with the ECU server 110 that is included in the vehicle attempting to be paired with the OBD device 115. In other cases, the ECU server 110 may not include the VIN of the vehicle, the memory in the ECU server 110 including the VIN may be corrupted or the VIN may have been corrupted during transmission.

At step 520, the VIN manager 150 stores the VIN message in the VIN database in association with an identifier of the OBD device 115 from which the message was received. The manual setting of the VIN begins at step 525. The manual setting process may be triggered by a user logging into the device manager 140 via the OBD UI 142 and requesting to input the VIN for the OBD device 115. The user may have already registered the OBD device 115 with the device manager 140 using the identifier of the OBD device that the VIN report message was stored in association with at step 520. At step 520, the MT monitor 146 triggers a manual input process using the OBD web services module 144. At step 530, the device manager receives a manual input of the VIN from the user via the OBD UI 142 and sends a request to decode the VIN to the VIN decoder service 155. After the VIN decoder service 155 decodes the VIN and determines the characteristics of the associated vehicle and ECU installed in the vehicle, the remaining steps of the message flow sequence 500 are the same as the final steps of the message flow sequence 400 except for step 560. Specifically, step 535 corresponds to step 425, step 540 corresponds to step 430, step 545 corresponds to step 435, step 550 corresponds to step 440, step 555 corresponds to step 445, step 565 corresponds to step 455, step 570 corresponds to step 460, step 575 corresponds to step 465, step 580 corresponds to step 470 and step 585 corresponds to step 475. At step 560, the CMS 160 sends the VIN that was manually input at step 525 to the OBD device 115 such that the OBD device 115 can use the VIN to tag future messages sent to the CMS 160 and/or the VIN manager 150.

The message flow diagrams 400 and 500 are exemplary only and the steps and/or the messages may change. For example, the messages may be sent to different components of the system 100 in a different order, and messages may be omitted and/or rearranged.

Referring now to FIG. 6, a flow chart of an example process 600 for discovery of an OBD device type and a vehicle type pair for determining a configuration for the OBD device 115 based on the pairing is shown. The process 600 may, for example, be carried out during the VIN reporting portions of the message flow sequences 400 (steps 405 through 440) or 500 (steps 505 through 550). The process 600 will now be described with further reference to the components of the system 100 of FIG. 1.

The process 600 starts at stage 605 where the VIN manager 150 receives a VIN reporting message from an OBD device 115. The VIN reporting message may include data indicative of a vehicle identifier (e.g., a VIN) and an OBD device type identifier. In some cases, the VIN reporting message may be received in two parts, a first part including the OBD device type identifier, and a second part including the VIN, where the VIN in the second part of the message may be input manually by a user as described above in reference to the message flow sequence 500 of FIG. 5.

The VIN report message may be sent at stage 605 using UDP or other messaging protocol. The VIN report message may include several fields indicative of the VIN as well as the PID fields supported by the particular OBD protocol of the OBD device 115. For example, the VIN report message may be configured to include the elements listed in Table 1 below. If the OBD device 115 is unable to read the vehicle VIN from the OBD port of the ECU server 110, the VIN element may be sent as all zeroes. A VIN report message may be sent following a “Power on Reset” (e.g., when a new OBD device is inserted into a new or old vehicle, or when an existing OBD device 115 is resent) of the OBD device 115 or when a new vehicle is connected to a new or old OBD device 115. In addition, the OBD device 115 may be triggered to send the VIN report message when the current vehicle VIN that it reads differs from the last vehicle VIN read by the OBD device 115, or when the current vehicle VIN is not retrievable by the OBD device 115.

TABLE 1

| Element | Width | Description |
|---|---|---|
| Tag | 2 byte | VIN Message tag |
| | | Current Version Tag: 0x0001 |
| VIN | 20 bytes | The unique VIN for the vehicle read |
| | | from the OBD port or all zeroes if no |
| | | VIN is read |
| PID bits 1-32 | 4 bytes | Bitmask of PID bits supported by OBD |
| | | device 115 |
| PID bits 33-64 | 4 bytes | Bitmask of PID bits supported |
| PID bits 65-96 | 4 bytes | Bitmask of PID bits supported |
| PID bits 97-128 | 4 bytes | Bitmask of PID bits supported |
| PID bits 129- | 4 bytes | Bitmask of PID bits supported |
| 160 | | |
| Modem ID | 22 bytes | The modem ID of the OBD device 115 |
| | | reporting |
| DEVTYP | 2 bytes | The value identifying the device type |
| | | (DEVTYP value) |
| FW Version | 4 bytes | Firmware version on OBD device 115 |
| | | (PKG) |
| OBD Type | 1 byte | The OBD protocol type (see Table 2 |
| | | below) |
| FW Version | 2 bytes | OBD protocol firmware version |
| | | (OBDVER) |
| Trailer | 2 bytes | Reserved for future use |

The VIN report message of Table 1 allows for various upgrades of the reporting protocol, as well as upgrades to the OBD device types and upgrades to the OBD protocol types. The “Tag” element is used to inform the VIN manager 150 of a version number of the VIN report message being reported by the OBD device. This allows for different versions of VIN report messages to be used as different firmware versions change. In addition, the VIN report message elements in Table 1 also include two “FW Version” elements, one corresponding to the “DEVTYP” element and another corresponding to the “OBD Type” element. These “FW Version” elements allow different device type models to be supported and different OBD protocol types to be supported.

The other elements of the VIN report message illustrated in Table 1 are similar to fields described in the ERD 300 of FIG. 3 as described above. These other elements of Tables 1 (and Table 2, discussed below) are used to populate some of the OBD related objects in the ERD 300. For Example, the “PID bits . . . ” elements are used to fill in the “PIDS . . . ” variables of the Obdinfo object 325, the “ModemID” element is used to fill in the DEVICEID variable of the Device object 310, the “DEVTYP” element is used to fill in the DEVICETYPEID variable of the Device object 310, the first “FW Version” element is used to fill in the PKG element of the Device object 310, and the “OBD Type” element along with the second “FW Version” element are used to fill in the PROTOCOLID variable of the Obdinfo object 325.

The OBD Type element is a number that identifies the type of OBD protocol supported. Example values of the “OBD Type” element are illustrated in Table 2.

TABLE 2

| OBD Type Value | OBD Protocol |
|---|---|
| 0 | ISO_15765_250 kHz_11bit |
| 1 | ISO_15765_500 kHz_11bit |
| 2 | ISO_15765_250 kHz_29bit |
| 3 | ISO_15765_500 kHz_29bit |
| 4 | J1850_PWM |
| 5 | J1850_VPW |
| 6 | ISO_9141_2 |
| 7 | ISO_14230 |

At stage 610, the VIN parser 156 parses the VIN message into the various elements and provides them to the vehicle resolver 152 and/or the VIN data manager 154 for further processing. For example, the VIN parser 156 may parse the OBD device related elements (e.g., the “PID bits . . . ”, “DEVTYP”, “OBD Type” and first and second “FW version” elements of Table 1) and the VIN from the VIN report message. The VIN parser 156 then sends the VIN to the vehicle resolver 152 and sends all the elements to the VIN data manager 154, which stores all the elements in the VIN database 170 (e.g., with the RDBMS using the ERD 300). If the VIN report message does not include a VIN, the VIN parser informs the VIN data manager 154 of the lack of the VIN and the VIN data manager 154 may inform the CMS 160 that the VIN needs to be retrieved manually using the device manager 140, for example, as described above.

At stage 615, the vehicle resolver 152 determines if the VIN/OBD device 115 pairing is new. The VIN/OBD device 115 pairing may be new if the VIN is new to the system 100 and/or if the OBD device 115 is new to the system 100. If the VIN/OBD device 115 pairing is not new, the process 600 may stop at stage 615. If the VIN/OBD device 115 pairing is new to the system, the vehicle resolver 152 determines a vehicle type based on the VIN. As described above, the vehicle resolver 152 may determine the vehicle type by querying the VIN decoder service 155 which may be internal to the VIN manager 150 or external to the VIN manager 150.

In response to receiving the VIN query from the vehicle resolver 152, the VIN decoder service 155 looks up the specific VIN and returns as many characteristics as are available for the VIN. These characteristics may be some or all of the characteristics described above in the Vehicle_type object 330 of the ERD 300. Other vehicle characteristics may also be returned to the vehicle resolver 152 in response to the query at stage 615. As an alternative to receiving all the characteristics from the decoder service 155, some vehicle characteristics may be input manually via the VIN UI 158. In addition, the query at stage 615 may be performed multiple times, e.g., in an iterative fashion, as more details about the vehicle are received from the OBD device 115 or input manually.

At stage 620, the VIN data manager 154 stores the vehicle characteristics data that was received at stage 615 in the VIN database 170. The vehicle characteristics data is stored in association with the VIN report message data that was parsed and stored at stage 610.

At stage 625, the VIN manager 150 sends a message to the CMS 160 informing the CMS 160 of the newly paired VIN and OBD device 115. As illustrated in FIG. 1, the vehicle resolver 152 sends the message to the CMS MQ module 130, from which the CMS 160 may retrieve the message. The message may include one or more of an OBD device identifier, the VIN, another vehicle identifier, or any identifier that may allow the CMS 160 to identify the specific portion of the ERD 300 of the VIN database 170 in which the OBD device/vehicle data is stored.

At stage 630, upon receiving the message regarding the new OBD device/vehicle pairing, the CMS configuration manager 162 may select the appropriate configuration files for the determined OBD device type and vehicle type and schedule a deployment to the OBD device 115. The CMS configuration manager 162 may determine which of the PIDs supported by the OBD device 115 are available for the particular vehicle as identified by the VIN (or other vehicle identifier). The determined configuration may allow the OBD device 115 to extract the maximum amount of data that is available from the vehicle including any parameters needed to access the data from the corresponding ECU server 110 in the vehicle. The configuration parameters may include, but not be limited to, bus identifiers, PID identifiers, timing related parameters, and others.

As described above, the configuration files sent by the CMS 160 at stage 630, may include algorithms necessary to transform the raw data retrieved by the OBD device 115. The algorithms may include any methods of conversion including scaling, shifting, masking, or combinations of these. The configuration may also include various algorithms to perform any necessary unit conversion (i.e. km to miles) in order to achieve a uniform data representation for reporting.

Based on the type of vehicle that a specific OBD device 115 is installed in, the OBD device 115 may require a different configuration file(s) to detail how to read the specific information from the OBD port of that vehicle's ECU. While the ultimate goal in determining the OBD configuration at stage 630 may be to determine a specific vehicle type identification and send parameters optimized specifically for that vehicle, this may not be possible on the first deployment due to missing information such as a VIN or specifics on the PIDs supported by a vehicle's ECU. So the initial configuration determined at stage 630 may be one that is the most specific that the vehicle characteristics stored at stage 620 may allow. For example, if the vehicle characteristics only include a year and make of the vehicle, then the determined OBD configuration may be a default configuration that matches the year and make of the vehicle. This default configuration may contain multiple ways to attempt to read one or more particular PID values. The OBD configuration files may be text files comprising AT commands for allowing the OBD device 115 to retrieve the specific parameters indicated by the PIDs.

At stage 630, the CMS configuration manager 162 and the OBD device 115 can sequence through multiple configuration files utilizing multiple methods of data access configurations in order to find a successful method to retrieve the desired parameter information from the specific vehicle's ECU. The sequencing at stage 630 proceeds and, if the ECU reports a negative response or, if a timeout period elapses while awaiting a response from the ECU, the CMS configuration manager 162 sequences to the next data access method until all the data retrieval methods are exhausted and an optimum configuration is determined for the OBD device 115.

At stage 635, the CMS data manager 164 stores data indicative of the determined OBD configuration in a database in association with identifiers of the OBD device 115 and/or the vehicle. The CMS data manager 164 may store the OBD configuration data in the VIN database 170, or in another database.

The stages of process 600 continue (as indicated by the arrow 640) as long as there are new VIN report messages remaining in the VIN queue memory 124. The stages of process 600 are only examples. The stages of the process 600 may be modified. For example, the stages of process 600 may be combined, omitted and/or rearranged.

After the process 600 has been completed, the CMS 160 waits for the OBD device 115 that the new OBD configuration was determined for to check in for deployment of the OBD configuration. The OBD device 115 may check in immediately after sending the VIN report message or may wait a predetermined amount of time to allow the process 600 to complete. In addition, the OBD device 115 may check in periodically to receive updated configuration files.

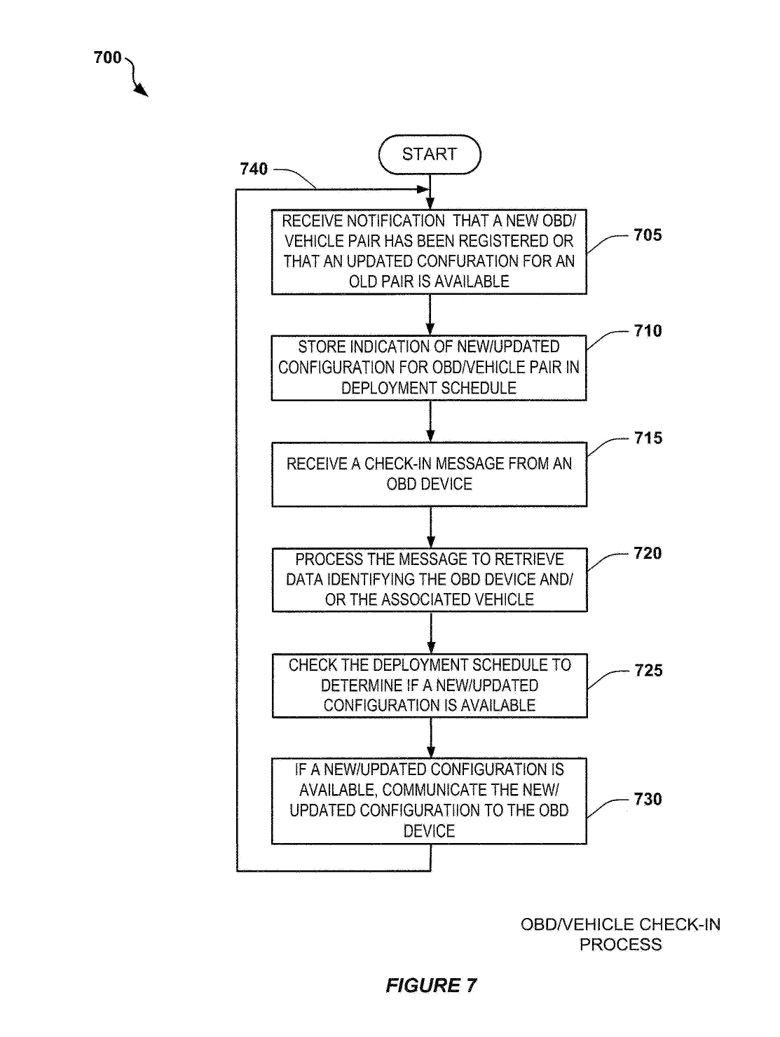

Referring now to FIG. 7, a flow chart of an example process 700 for configuring an OBD device with an OBD configuration based on a pairing of the OBD device 115 with a specific vehicle type is shown. The process 700 may be performed when the OBD device 115 sends a check-in message for the first time after the process 600 of FIG. 6 has been completed, or when the OBD device 115 is performing a periodic check-in. The process 700 may, for example, be carried out during the check-in portions of the message flow sequences 400 (steps 445 through 460) or 500 (steps 555 through 570). The process 700 will now be described with further reference to the components of the system 100 of FIG. 1.

The process 700 may start at stage 705, where the CMS 160 receives a notification that one of two events has occurred: 1) a new OBD device 115/vehicle pairing has been entered into the system (e.g., using the process 600 described above); or 2) an updated configuration for an existing OBD device 115/vehicle pairing is available. The notification of the new OBD device 115/vehicle pairing may be received from the VIN manager 150 (the vehicle resolver 152, in one example) via the CMS MQ 130. The notification of an updated configuration may be received from the device manager 140 via the CMS MQ 130.

At stage 710, the OBD configuration manager 162 stores an indication of the new/updated configuration for the OBD device 115/vehicle pairing in a deployment schedule database of the CMS 160. At stage 715, the CMS MQ 130 receives a check-in message from the OBD device 115 associated with the scheduled deployment indication. At stage 720, the OBD configuration manager 162 retrieves the check-in message from the CMS queue memory 134 and processes the check-in message to retrieve data identifying one or more of the OBD device 115, the vehicle or the OBD device 115/vehicle pairing.

At stage 725, the OBD configuration manager checks the deployment schedule database to determine if a new or updated configuration is available for the OBD device 115. Since the OBD device 115 may be configured to check-in periodically, there may or may not be an updated configuration available.

At stage 730, if a new or updated configuration is available, the CMS data manager 164 retrieves the new or updated configuration files from the VIN database 170 (or another database associated with the CMS 160). The OBD configuration manager 162 communicates the new or updated configuration files (e.g., in a JMS message) to the CMS MQ 130 which then communicates the new or updated configuration files to the OBD device 115.

The stages of process 700 continue as long as there are new check-in messages to be retrieved as indicated by the arrow 740. The stages of process 700 are only examples. The stages of the process 700 may be modified. For example, the stages of process 700 may be combined, omitted and/or rearranged.

After the process 700 has been completed, the OBD device 115 is able to retrieve ECU data from its associated ECU server 110 and communicate ECU messages to the VIN manager 150 using the new or updated configuration. The OBD device 115 may communicate ECU messages to the VIN manager 150 periodically or when the user or a maintenance person retrieves ECU information with the OBD device 115.

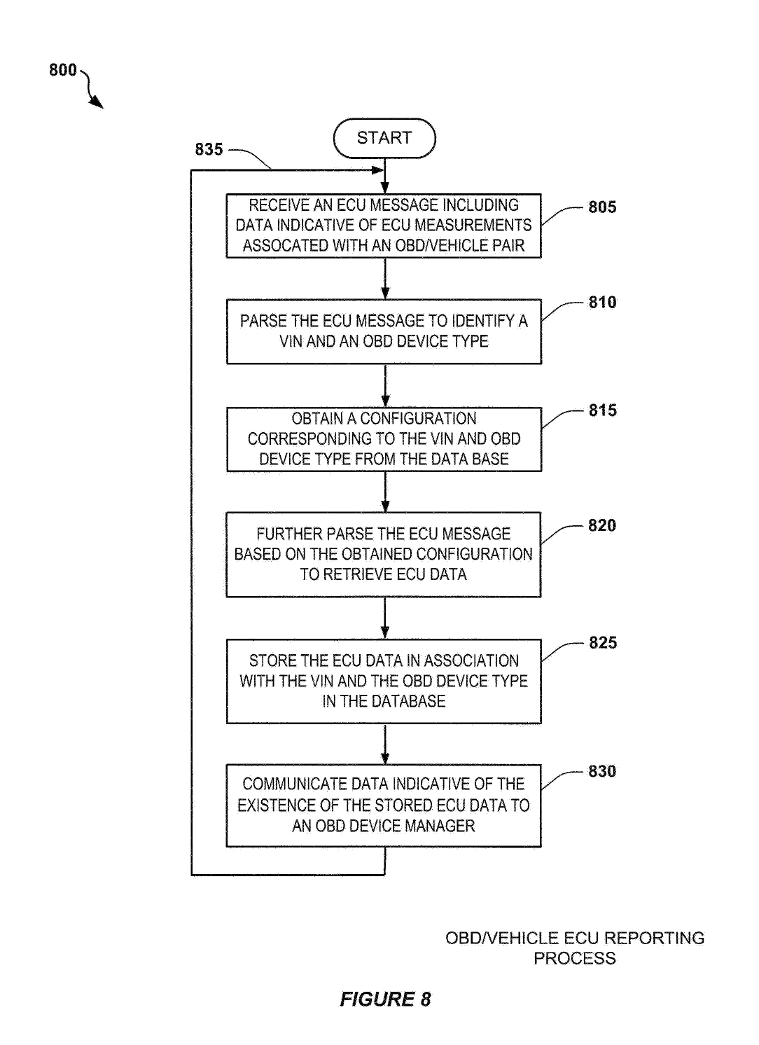

Referring now to FIG. 8, a flow chart of an example process 800 for for receiving ECU message data from an OBD device 115 is shown. The process 800 may, for example, be carried out during the ECU message portions of the message flow sequences 400 (steps 465 through 475) or 500 (steps 575 through 585). The process 800 will now be described with further reference to the components of the system 100 of FIG. 1.

The process 800 may start at stage 805, where the VIN manager 150 receives an ECU message from an OBD device 115 via the VIN MQ module 120, the ECU message including data indicative of ECU measurements associated with an OBD device 115 that has been configured using the processes 600 and 700 described above.

The ECU message may include the fields illustrated in Table 3:

TABLE 3

| Element | Width | Description |
|---|---|---|
| Tag | 2 byte | ECU Message tag |
| | | Current Version Tag: 0x0101 |
| VIN | 20 bytes | The unique VIN for the vehicle read from the |
| | | OBD port or all zero if no VIN is read |
| ECU Length | 1 byte | Length of ECU version is following |
| | | field, 0 if absent |
| ECU Version | 15 bytes | Raw value of ECU version or all zero if ECU |
| | | version is not read, value is left justified |
| Number of Status | 1 byte | Number of Parm/Status/Groups to follow |
| Groups | | |
| Parameter Number | 1 bytes | OEM Parameter Number |
| Status | 1 byte | Status (0 = Fail, 1 = Success, 2 = Not |
| | | configured) |
| Group | 1 byte | Group Number |
| Trailer | 2 bytes | Reserved for future use |

The ECU report message may be sent over UDP using an AT command. If the OBD device 115 is unable to read the vehicle ECU version from the OBD port or the OBD device 115 was not configured to read the ECU version, the ECU version element may be sent as all zeros. An ECU report may be sent following the initial read of a valid ECU version. ECU version reading may be contingent upon provisioning of an AT command describing how to request the ECU version.

In the example ECU report message of Table 3, a Tag element informs the VIN manager 150 that the message is specific version of an ECU message, thus allowing for changes in ECU configurations over time. An ECU Length element defines a length of ECU version data in an ECU version field. The default ECU length may be zero of the ECU Version is absent.

The ECU data is contained in a Number of Status Groups, each Status Group including a Parameter Number element, a Status element and a Group element. The Status element indicates whether a specific parameter was read successfully or not from the ECU. The Group element defines a group of related measures that may include one or more Parameter Numbers. A Trailer element may be included for future use. The ECU message of Table 3 is exemplary only and other message configurations may be used.

At stage 810 the VIN parser 156 parses the ECU message to identify the VIN (or another vehicle identifier) and/or the OBD device 115 in order to be able to identify the pairing. At stage 815, the VIN data manager 154 obtains a configuration corresponding to the identified OBD device 115/vehicle pairing from the VIN database 170.

At stage 820, the VIN parser 156 further parses the ECU message based on the configuration obtained at stage 815 in order to retrieve the ECU data contained in the ECU message. At stage 825, the VIN data manager 154 stores the ECU data in association with the OBD device/pairing identifiers in the VIN database 170. At stage 830, the VIN manager 150 communicates data indicative of the existence of the newly stored ECU data to the device manager 140 associated with the OBD device 115. The indication of the new ECU data may first be communicated to the CMS 160, which may then communicate the indication to the device manager 140. Once the device manager 140 receives the indication of the new data, the device manager 140 may retrieve the new data from the VIN database 170 such that is immediately available to the user via the OBD UI 142. Alternatively, the device manager 140 may wait for a request to retrieve the data where the request may be received from the user or a maintenance person that is performing maintenance on the vehicle.

The stages of process 800 may continue as long as there are new ECU messages to be retrieved as indicated by the arrow 835. The stages of process 800 are only examples. The stages of the process 800 may be modified. For example, the stages of process 800 may be combined, omitted and/or rearranged.

Various embodiments of the present invention may be implemented in a system having multiple communication devices that can communicate through one or more networks. The system may comprise any combination of wired or wireless networks such as a mobile telephone (e.g., cellular) network, a wireless Local Area Network (LAN) such as WiFi®, a Bluetooth® personal area network, a Zigbee® personal area network, an Ethernet LAN, a wide area network, the Internet, etc.

The communication devices may communicate using various transmission technologies such as OFDM, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
receiving data indicative of an asset identifier associated with a mechanical asset coupled to a communication device, the communication device configured to retrieve data from a monitoring device of the mechanical asset;
receiving data indicative of a device type of the communication device;
determining characteristics of an asset type based on the asset identifier data;
storing data indicative of the asset type, the determined characteristics, and the communication device type; and
based on the determined characteristics and the communication device type, determining a configuration for the communication device to retrieve the data from the monitoring device.

2. The method of claim 1, wherein the mechanical asset is a vehicle, the communication device is an on board diagnostic (OBD) device, and the asset identifier is a vehicle identification number (VIN), the method further comprising:
querying a vehicle decoder service to determine the characteristics of the vehicle.

3. The method of claim 1, further comprising:
communicating data indicative of the determined configuration to the communication device.

4. The method of claim 3, further comprising:
receiving a first message from the communication device, the first message containing the data indicative of the asset identifier and the data indicative of the device type; and
based on the data in the first message, retrieving the data indicative of the determined configuration that is communicated to the communication device.

5. The method of claim 4, further comprising,
storing the data indicative of the determined configuration in a database; and
storing an indication of the stored data indicative of the determined configuration in a deployment schedule,
wherein the data indicative of the determined configuration is retrieved from the database and retrieving the data indicative of the determined configuration is further based on the indication in the deployment schedule.

6. The method of claim 3, further comprising:
receiving a second message from the communication device, the second message including data indicative of data retrieved from the monitoring device;
parsing the second message to identify at least one of the mechanical asset and the communication device;
identifying the determined configuration for the communication device based on at least one of the identification of the mechanical asset and the identification of the communication device; and
based on the configuration, further parsing the second message to retrieve the data indicative of the data retrieved from the monitoring device.

7. The method of claim 1, further comprising, prior to determining the configuration for the communication device, receiving the data indicative of the asset identifier from the communication device.

8. The method of claim 1, wherein the determined configuration comprises at least one of:
a bus identifier for the communication device to retrieve the data from the monitoring device;
at least one parameter identifier (PID) of a parameter to retrieve from the monitoring device; and
timing related parameters related to retrieving the data from the monitoring device.

9. The method of claim 1, wherein the asset identifier is input manually via a user interface.

10. The method of claim 1, further comprising determining additional characteristics of the asset type by receiving manual input via a user interface.

11. A system, comprising:
at least one server device, the at least one server device configured to:
receive data indicative of an asset identifier associated with a mechanical asset coupled to a communication device, the communication device configured to retrieve data from a monitoring device of the mechanical asset;
receive data indicative of a device type of the communication device;
determine characteristics of an asset type based on the asset identifier data;
store data indicative of the asset type, the determined characteristics, and the communication device type; and
based on the determined characteristics and the communication device type, determine a configuration for the communication device to retrieve the data from the monitoring device.

12. The system of claim 11, wherein the mechanical asset is a vehicle, the communication device is an on board diagnostic (OBD) device, and the asset identifier is a vehicle identification number (VIN), the at least one server device further configured to:
query a vehicle decoder service to determine the characteristics of the vehicle.

13. The system of claim 11, wherein the at least one server is further configured to:
communicate data indicative of the determined configuration to the communication device.

14. The system of claim 13, wherein the at least one server device is further configured to:
receive a first message from the communication device, the first message containing the data indicative of the asset identifier and the data indicative of the device type; and
based on the data in the first message, retrieve the data indicative of the determined configuration that is communicated to the communication device.

15. The system of claim 14, wherein the at least one server device is further configured to:
store the data indicative of the determined configuration in a database; and
store an indication of the stored data indicative of the determined configuration in a deployment schedule,
wherein the data indicative of the determined configuration is retrieved from the database and retrieving the data indicative of the determined configuration is further based on the indication in the deployment schedule.

16. The system of claim 11, wherein the at least one server device is further configured to:
receive a second message from the communication device, the second message including data indicative of data retrieved from the monitoring device;
parse the second message to identify at least one of the mechanical asset and the communication device;
identify the determined configuration for the communication device based on at least one of the identification of the mechanical asset and the identification of the communication device; and
based on the configuration, further parse the second message to retrieve the data indicative of the data retrieved from the monitoring device.

17. The system of claim 11, wherein the at least one server device is further configured to, prior to determining the configuration for the communication device, receive the data indicative of the asset identifier from the communication device.

18. The system of claim 11, wherein the determined configuration comprises at least one of:
a bus identifier for the communication device to retrieve the data from the monitoring device;
at least one parameter identifier (PID) of a parameter to retrieve from the monitoring device; and
timing related parameters related to retrieving the data from the monitoring device.

19. The system of claim 11, wherein the asset identifier is input manually via a user interface.

20. The method of claim 11, wherein the at least one server device is further configured to determine additional characteristics of the asset type by receiving manual input via a user interface.

21. A communication device, comprising:
a processor; and
a memory storing program code, the program code configured to cause the processor and the communication device to:
retrieve an asset identifier from a monitoring device monitoring a mechanical asset, the communication device being communicatively coupled the monitoring device,
send data indicative of the asset identifier to a remote server device,
send data indicative of a device type of the communication device to the remote server device; and
subsequent to sending the data indicative of the asset identifier and the device type, receiving data indicative of a configuration to retrieve data from the monitoring device, the configuration being based on characteristics of an asset type associated with the mechanical asset identified by the asset identifier and the device type.

22. The communication device of claim 21, wherein the mechanical asset is a vehicle, the communication device is an on board diagnostic (OBD) device, and the asset identifier is a vehicle identification number (VIN).

23. The communication device of claim 21, wherein the memory further comprises program code to cause the processor and the communication device to:
retrieve data from the monitoring device based at least in part on the received configuration; and
send a message to the server device, the message comprising data indicative of the data retrieved from the monitoring device and at least one of data indicative of the asset identifier and data indicative of the device type.

24. The communication device of claim 21, wherein the received configuration comprises at least one of:
a bus identifier for the communication device to retrieve the data from the monitoring device;
at least one parameter identifier (PID) of a parameter to retrieve from the monitoring device; and
timing related parameters related to retrieving the data from the monitoring device.

25. The communication device of claim 21, wherein the memory further comprises program code to cause the processor and the communication device to send and receive data over at least one of a cellular network, a Bluetooth network, a WiFi network and a ZigBee network.
